(19) United States
(12) Patent Application Publication
(10) Pub. No.: US 2026/0063866 A1
(43) Pub. Date: Mar. 5, 2026

(54) OPERATION DEVICE, LENS DEVICE, AND IMAGING APPARATUS

(71) Applicant: FUJIFILM Corporation, Tokyo (JP)

(72) Inventor: Koki HOJO, Saitama-shi (JP)

(73) Assignee: FUJIFILM Corporation, Tokyo (JP)

(21) Appl. No.: 19/308,306

(22) Filed: Aug. 24, 2025

(30) Foreign Application Priority Data
Aug. 30, 2024 (JP) 2024-148377

(51) Int. Cl. G02B 7/16

(52) U.S. Cl. CPC G02B 7/16

(57) ABSTRACT

Provided are an operation device, a lens device, and an imaging apparatus that allow an operation state of an operation member to be easily grasped. An operation device includes a base member; an annular operation member that is provided on the base member and is rotatable around an axis; and a click mechanism that imparts a first click feeling at a first position, imparts a second click feeling weaker than the first click feeling at a second position, and imparts a third click feeling weaker than the second click feeling at a third position, with respect to rotation of the operation member. A plurality of the click mechanisms are disposed.

### CROSS-REFERENCE TO RELATED APPLICATION

The present application claims priority under 35 U.S.C § 119 (a) to Japanese Patent Application No. 2024-148377 filed on Aug. 30, 2024, which is hereby expressly incorporated by reference, in its entirety, into the present application.

### BACKGROUND OF THE INVENTION

### 1. Field of the Invention

The present invention relates to an operation device, a lens device, and an imaging apparatus, and particularly to an operation device, a lens device, and an imaging apparatus having a click mechanism.

### 2. Description of the Related Art

WO2017/047592A describes that in an operation ring for stop operation provided in a lens barrel, different click feelings are applied in a case where the operation ring is aligned with a first rotational position corresponding to a main series and in a case where the operation ring is aligned with a second rotational position corresponding to a sub-series.

JP2020-181021A describes that a plurality of click mechanisms are provided in an operation ring provided in a lens barrel, and the number of clicks is increased by sequentially operating the click mechanisms.

JP1982-00707U (JP S57-00707U) describes that all click-stop operations in the same functional range are made to have the same weight, and the click-stop operation is made heavier only in a case of transition to a different functional position.

### SUMMARY OF THE INVENTION

One embodiment according to the technology of the present disclosure provides an operation device, a lens device, and an imaging apparatus that allow an operation state of an operation member to be easily grasped.

[1] An operation device comprising: a base member; an annular operation member that is provided on the base member and is rotatable around an axis; and a click mechanism that imparts a first click feeling at a first position, imparts a second click feeling weaker than the first click feeling at a second position, and imparts a third click feeling weaker than the second click feeling at a third position, with respect to rotation of the operation member, in which a plurality of the click mechanisms are disposed.

[2] The operation device according to [1], in which the plurality of click mechanisms are disposed to face the axis.

[3] The operation device according to [1] or [2], in which the click mechanism includes an engaging member that is provided on one of the base member and the operation member and that is biased toward the other, a first engaging part that is provided on the other of the base member and the operation member and with which the engaging member is engaged in a case where the operation member is positioned at the first position, a second engaging part that is provided on the other of the base member and the operation member and with which the engaging member is engaged in a case where the operation member is positioned at the second position, and a third engaging part that is provided on the other of the base member and the operation member and with which the engaging member is engaged in a case where the operation member is positioned at the third position, and shapes of the first engaging part, the second engaging part, and the third engaging part are different from each other.

[4] The operation device according to [3], in which at least a portion of the engaging member is formed in a spherical shape or an arc shape, and the first engaging part, the second engaging part, and the third engaging part are composed of recessed portions.

[5] The operation device according to [4], in which each of the recessed portions has a tapered inner wall surface, and an angle formed by the inner wall surface differs between the first engaging part, the second engaging part, and the third engaging part.

[6] The operation device according to [5], in which, in a case where the angle in the first engaging part is α, the angle in the second engaging part is β, and the angle in the third engaging part is γ, a relationship of α<β<γ is satisfied.

[7] The operation device according to [6], in which a difference between the angle α and the angle β is different from a difference between the angle β and the angle γ.

[8] The operation device according to [7], in which a difference between the angle α and the angle β is larger than a difference between the angle β and the angle γ.

[9] The operation device according to any one of [6] to [8], in which the angle α, the angle β, and the angle γ are obtuse angles.

The operation device according to any one of [3] to [9], in which the engaging member is engaged with the first engaging part, the second engaging part, and the third engaging part at the same position in a biasing direction.

The operation device according to any one of [3] to [10], in which an outer diameter of the portion having the spherical shape or the arc shape is less than 1.5 mm.

The operation device according to any one of [3] to [11], in which the operation member has a grip portion, and the grip portion is disposed at a position at a rotation angle of less than 30° from a position of the first engaging part.

The operation device according to any one of [1] to [12], in which a plurality of the second positions and a plurality of the third positions are provided within a predetermined range of rotation angles, and the first position is provided at a position outside the range.

The operation device according to any one of [1] to [13], in which a plurality of the second positions are provided within a predetermined range of rotation angles, and a third position is provided between the second positions adjacent to each other.

The operation device according to [14], in which a plurality of the third positions are provided between the second positions adjacent to each other.

A lens device comprising: the operation device according to any one of [1] to [15], in which the base member constitutes a fixed portion of a lens barrel, and the operation member constitutes an operation ring provided on an outer periphery of the lens barrel.

An imaging apparatus comprising the lens device according to and a main body that captures an image formed by the lens device.

### BRIEF DESCRIPTION OF THE DRAWINGS

FIG. 1 is a front view showing an embodiment of an imaging apparatus.

FIG. 2 is a rear view of the imaging apparatus shown in FIG. 1.

FIG. 3 is a top view of the imaging apparatus shown in FIG. 1.

FIG. 4 is a diagram showing a schematic configuration of a click mechanism provided in a stop ring.

FIG. 5 is a diagram showing a schematic configuration of a click mechanism provided in a stop ring.

FIG. 6 is an enlarged cross-sectional view of a part of a lens barrel including the stop ring.

FIG. 7 is a development diagram of grooves provided in the stop ring.

FIG. 8 is a diagram comparing the shapes of grooves at respective positions.

FIG. 9 is a diagram illustrating a force acting on the stop ring via a ball.

FIG. 10 is a view showing another example of an engaging member.

FIGS. 11A and 11B are views showing another example of an engaging part.

FIG. 12 is a view showing another example of the engaging part.

FIG. 13 is an enlarged view of a part of the stop ring shown in FIG. 12.

### DESCRIPTION OF THE PREFERRED EMBODIMENTS

Hereinafter, preferred embodiments of the present invention will be described in detail with reference to the attached drawings.

Here, a case where the present invention is applied to an operation device that operates a stop of a lens in an imaging apparatus will be described as an example. In particular, a case where the present invention is applied to an operation device that operates a stop by an operation ring provided in a lens will be described as an example. The operation ring provided in the lens is a link-shaped operation member that is provided on an outer periphery of a lens barrel portion of the lens and is rotationally operated around an axis. The operation ring used for the operation of the stop is particularly referred to as a “stop ring” and is distinguished from other operation rings, for example, an operation ring (focus ring) used for focus operation and an operation ring (zoom ring) used for zoom operation.

In the operation device of the stop, a setting operation of an F number is performed. Specifically, an operation of selecting one from a plurality of prepared F numbers is performed. In the case of the stop ring, a selectable F number is determined for each rotational position, and the F number to be set is switched by switching the rotational position.

In addition, in the operation device of the stop, an operation of switching an operation mode of the stop is also performed. That is, an operation of switching between a mode (auto mode) in which the F number is automatically set and a mode (manual mode) in which the F number is manually set is performed. In the case of the stop ring, the stop ring is set to the auto mode in a case where the stop ring is rotated to a predetermined rotational position, and the stop ring is set to the manual mode in a case where the stop ring is rotated to the other rotational position, that is, a position where the F number is selected.

In this way, in the case of the stop ring, the operation mode of the stop is switched depending on the rotational position, and the set F number is switched.

One embodiment according to the technology of the present disclosure provides an operation device in which the operation state of an operation member is easily grasped, and a lens device and an imaging apparatus, comprising the operation device.

### Imaging Apparatus

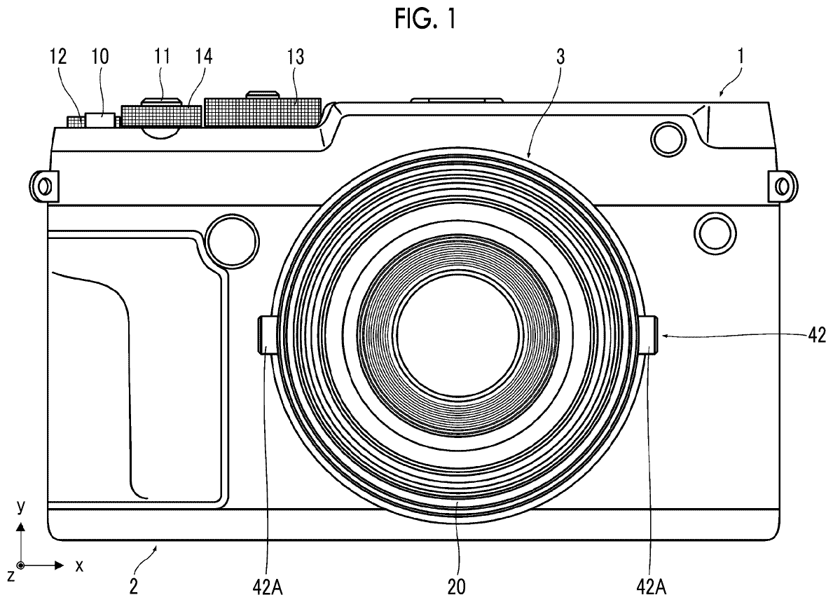

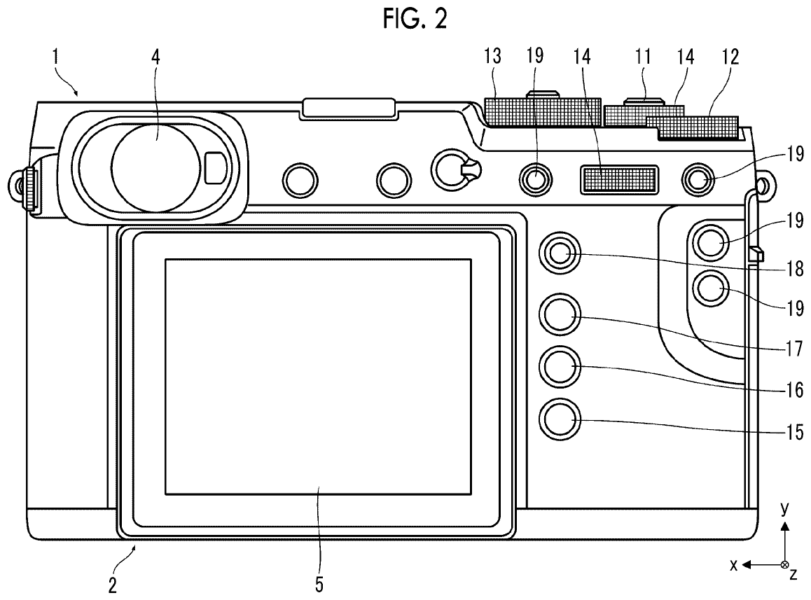

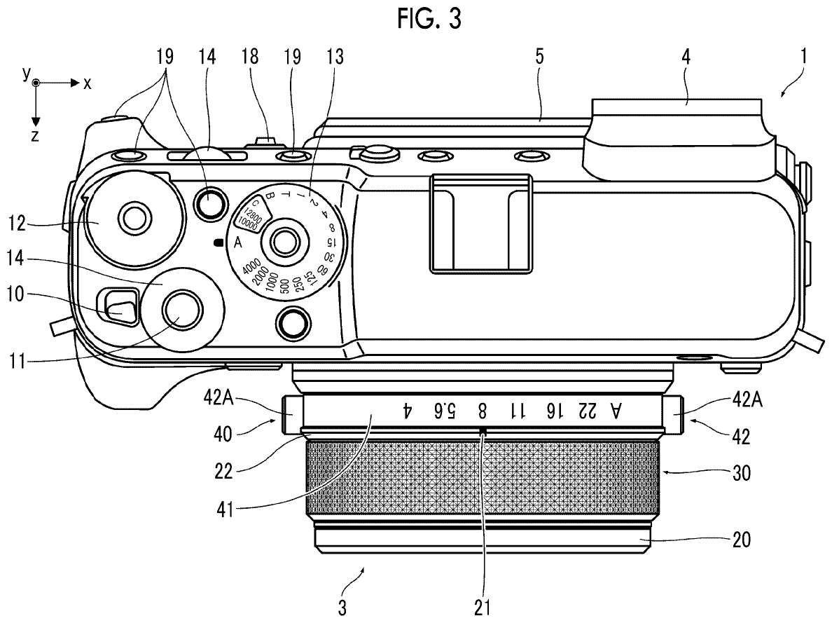

FIG. 1 is a front view showing an embodiment of an imaging apparatus to which the present invention is applied. FIG. 2 is a rear view of the imaging apparatus shown in FIG. 1. FIG. 3 is a top view of the imaging apparatus shown in FIG. 1.

The imaging apparatus shown in FIGS. 1 to 3 is a lens-integrated digital camera. That is, the digital camera is a digital camera (so-called compact digital camera) in which a lens is integrally attached to a main body and is not replaceable. In particular, the imaging apparatus of the present embodiment is a digital camera (so-called medium format digital camera) equipped with a large image sensor (for example, approximately 44 mm×approximately 33 mm). In addition, the imaging apparatus of the present embodiment is a digital camera using a so-called single focus lens (a lens with a fixed focal length). Hereinafter, in the present embodiment, the imaging apparatus will be referred to as a “camera”.

As shown in FIGS. 1 to 3, the camera 1 of the present embodiment is mainly composed of a body part 2 and a lens part 3. As described above, the camera 1 is of a lens-integrated type. The lens part 3 is integrally provided on the body part 2. In the present embodiment, the lens part 3 is an example of the lens device. In addition, the body part 2 is an example of the main body.

An image sensor (not shown) has the body part 2 built in. The image sensor is disposed on an optical axis of the lens part 3. An image of a subject formed by the lens part 3 is captured by the image sensor and is recorded in a storage as digital data. The storage is composed of, for example, an internal memory and/or an external memory (so-called memory card).

The body part 2 is provided with a finder 4, a monitor 5, a battery loading portion (not shown), and the like, in addition to various operation members and various interfaces.

The operation member includes a power lever 10, a shutter button 11, an exposure correction dial 12, a shutter speed dial 13, a command dial 14, a DISP/BACK button 15, a play button 16, a MENU/OK button 17, a focus lever 18, a function button 19, and the like.

The interface includes a power terminal, a universal serial bus (USB) terminal, a memory card slot, and the like (none of which are shown).

The finder 4 is composed of, for example, an electronic viewfinder (EVF).

The monitor 5 is composed of, for example, a touch panel type liquid crystal display.

The equipment is provided in general digital cameras. Therefore, a detailed description thereof will be omitted.

The lens part 3 is provided on a front surface of the body part 2. As described above, the lens part 3 is composed of a so-called single focus lens. As an example, the focal length is f=50 mm (corresponding to 40 mm in terms of so-called 35 mm format).

As shown in FIG. 3, the lens part 3 comprises a focus ring 30 and a stop ring 40 on an outer periphery of the lens barrel 20. In the present embodiment, the focus ring 30 is disposed on an object side (front side), and the stop ring 40 is disposed on an image side (rear side).

The focus ring 30 is an operation member used for focus adjustment. The focus ring 30 is provided around the lens barrel 20 so as to be rotatable forward and backward. In a case where the focus ring 30 is rotated clockwise, the focus is adjusted to a long distance side, and in a case where the focus ring 30 is rotated counterclockwise, the focus is adjusted to a short distance side. The rotation direction and the focusing direction can be reversed by setting. The focus is moved with a variable movement amount according to the rotation speed of the focus ring 30. In addition, a configuration in which the focus is linearly moved with respect to the rotation amount regardless of the rotation speed can also be adopted by setting.

The focus ring 30 has an annular shape and is disposed on the outer periphery of the lens barrel 20 with a predetermined width in the optical axis direction. In addition, the outer periphery of the focus ring 30 is subjected to knurling and has a regular pattern of unevenness.

In addition, other functions can be assigned to the focus ring 30 by setting. As an example, a digital telecon function, a white balance function, and the like can be selectively assigned. The digital telecon refers to a function of capturing an enlarged image with different focal lengths by image processing. The magnification ratio is selected by the rotational operation of the focus ring 30. In addition, the focus ring 30 may be configured to automatically switch functions according to the mode of the camera 1.

The stop ring 40 is an operation member used for adjusting the stop. The stop ring 40 is provided to be rotatable forward and backward around the lens barrel 20 within a predetermined angular range.

The manual adjustment of the stop is valid only in a case where a predetermined imaging mode is set. As an example, in the camera 1 of the present embodiment, four imaging modes of a program imaging mode, a shutter speed priority imaging mode, an aperture stop priority imaging mode, and a manual imaging mode are prepared as the imaging modes, and the manual stop adjustment is possible only in a case where the aperture stop priority imaging mode and the manual imaging mode is set.

The program imaging mode is a mode in which the camera 1 automatically sets shutter speed and the F number to perform imaging. In the program imaging mode, the combination of the shutter speed and the F number can be changed while maintaining the same exposure value by operating the command dial 14 (so-called program shift). In a case where the program imaging mode is set, the shutter speed dial 13 is set to an A-position (auto position), and the stop ring 40 is set to the A-position (auto position).

The shutter speed priority imaging mode is a mode in which the camera 1 automatically determines and sets the F number in accordance with the shutter speed set by a user and performs imaging. In a case where the shutter speed priority imaging mode is set, the stop ring 40 is set to the A-position. The shutter speed is set by the shutter speed dial 13.

The aperture stop priority imaging mode is a mode in which the camera 1 automatically determines a shutter speed and performs imaging in accordance with a F number set by the user. In a case where the aperture stop priority imaging mode is set, the shutter speed dial 13 is set to the A-position. The F number is set by the stop ring 40.

The manual imaging mode is a mode in which the user sets the shutter speed and the F number to perform imaging. The shutter speed is set by the shutter speed dial 13, and the F number is set by the stop ring 40.

As an example, the camera 1 of the present embodiment is configured to allow the F number to be set in ⅓ stop steps, with F4 as the open stop and F22 as the minimum stop. Therefore, settable F numbers are “F4”, “F4.5”, “F5”, “F5.6”, “F6.3”, “F7.1”, “F8”, “F9”, “F10”, “F11”, “F13”, “F14”, “F16”, “F18”, “F20”, and “F22” in order from an open side. Among these, “F4”, “F5.6”, “F8”, “F11”, “F16”, and “F22” are F numbers in a case where the F number is changed by one stop each. F numbers in a case where the F number is changed by one stop are defined as main-series F numbers, and the other F numbers are defined as sub-series F numbers. Therefore, in the present embodiment, “F4”, “F5.6”, “F8”, “F11”, “F16”, and “F22” are the main-series F numbers, and “F4.5”, “F5”, “F6.3”, “F7.1”, “F9”, “F10”, “F13”, “F14”, “F18”, and “F20” are the sub-series F numbers. In the present embodiment, a configuration is adopted in which two sub-series F numbers are disposed between main-series F numbers adjacent to each other.

As shown in FIG. 3, for the main-series F numbers (“F4”, “F5.6”, “F8”, “F11”, “F16”, and “F22”), the position to be aligned with an indicator 21 provided on the outer periphery of the lens barrel 20 is marked on the outer peripheral surface of the stop ring 40. FIG. 3 shows a state where the F number is set to F8. In this case, as shown in FIG. 3, the position of the mark F8 is aligned with the indicator 21.

The indicator 21 is provided on the outer periphery of a fixed ring 22. The fixed ring 22 is a stationary member that is fixed to the lens barrel 20. In the present embodiment, the fixed ring 22 is disposed between the focus ring 30 and the stop ring 40. In addition, in the present embodiment, the indicator 21 is disposed at a position vertically above the optical axis in a cross section orthogonal to the optical axis.

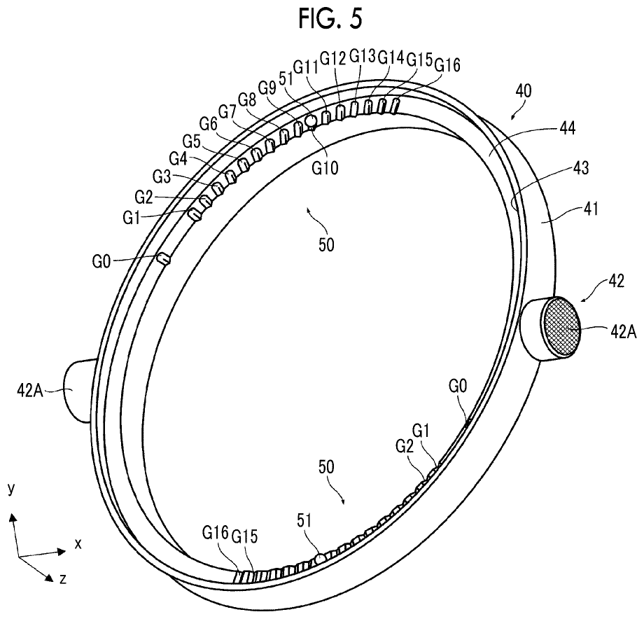

The stop ring 40 has an annular stop ring body 41. The stop ring body 41 is disposed on the outer periphery of the lens barrel 20 with a predetermined width in the optical axis direction. As shown in FIGS. 1 and 3, the stop ring 40 includes a grip portion 42 on an outer periphery of the stop ring body 41. In the present embodiment, the grip portion 42 is composed of a pair of protruding portions 42A. The pair of protruding portions 42A have a columnar shape and are disposed symmetrically with the optical axis interposed therebetween. An end surface (top portion) of the protruding portion 42A is subjected to knurling and has unevenness in a regular pattern (see FIG. 5). The user grips the stop ring 40 by pinching the grip portion 42 composed of the pair of protruding portions 42A with the thumb and the index finger (or the middle finger) and rotationally operates the stop ring 40.

The stop ring 40 is provided with a click mechanism, which imparts a click feeling to the rotational operation. In other words, a configuration is provided which a click-stop is made at the position (including the A-position) of each F number in a case where the rotational operation is performed. The click-stop means that an operation is stopped with a click feeling.

In the present embodiment, a click feeling is imparted to the rotational operation of the stop ring 40 for all the positions (including the auto position) of the settable F numbers. That is, the stop ring 40 is configured to click-stop at all the positions of the settable F numbers. In particular, in the present embodiment, a click feeling different depending on the rotational position is imparted. Specifically, different click feelings are imparted to the A-position, the positions of the main-series F numbers, and the positions of the sub-series F numbers. The click feeling to be imparted is the strongest at the A-position, and the click feeling is the second strongest at the positions of the main-series F numbers and the weakest at the position of the sub-series F numbers.

The strength of the click feeling has a correlation with a force (torque) in the rotation direction required for the operation of switching positions. Specifically, as the force required for the operation of switching positions increases, the click feeling becomes stronger. In other words, as the click feeling becomes stronger, a larger force is required for the operation of switching positions. For example, in a case where a force required to switch from a position P2 to a position P1 is larger than a force required to switch from the position P1 to the position P2, the click feeling at the position P1 is stronger. Therefore, the strength of the click feeling at each position is substantially synonymous with the magnitude of the force (torque) in the rotation direction required for the operation of switching positions.

Hereinafter, the click mechanism provided in the stop ring 40 will be described.

### Click Mechanism of Stop Ring

In the click mechanism of the stop ring 40 of the present embodiment, a biased ball (hard ball) is engaged with a groove provided corresponding to the position (including the A-position) of each F number to generate a click feeling for the rotational operation to the position of each F number. In particular, in the stop ring 40 of the present embodiment, a predetermined click feeling is generated by using a plurality of click mechanisms consisting of the groove and the ball.

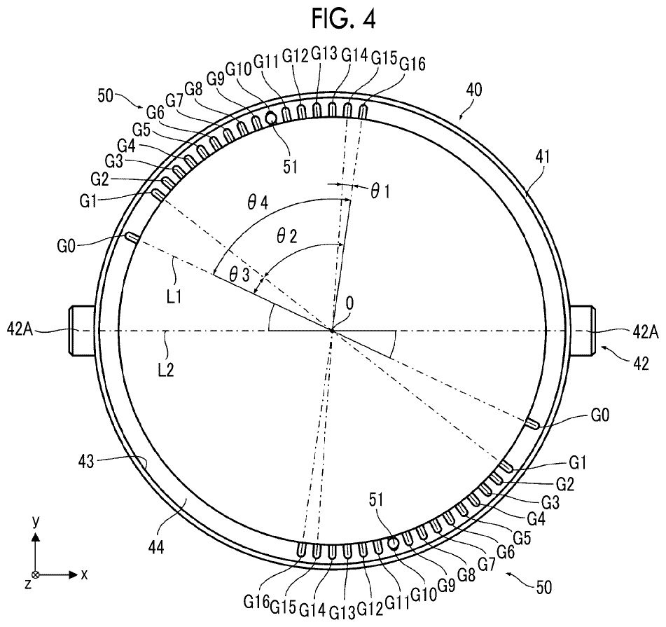

FIGS. 4 and 5 are diagrams showing a schematic configuration of the click mechanism provided in the stop ring. FIG. 4 corresponds to a view (rear view) of the stop ring including the ball as viewed from a rear side (a body part 2 side of the camera 1). In addition, FIG. 5 corresponds to a perspective view of the stop ring including the ball as viewed from the rear side.

As shown in FIG. 4, the stop ring 40 of the present embodiment comprises click mechanisms 50 at two positions in the circumferential direction. That is, the stop ring 40 of the present embodiment imparts a click feeling to the rotational operation with the two click mechanisms 50.

The two click mechanisms 50 have the same configuration and are disposed to be shifted from each other in the circumferential direction. As an example, in the present embodiment, the two click mechanisms 50 are disposed to face each other with respect to the rotation axis (=optical axis) O of the stop ring 40. By disposing the two click mechanisms in this way, the positions where the load is applied can be evenly distributed, and the rotational operation can be smoothly performed. In addition, a click feeling can be imparted in a well-balanced manner.

In a case where the stop ring 40 is rotationally operated, the two click mechanisms 50 have balls that are engaged with grooves (grooves corresponding to the same F number) at the same disposition positions at the same timing, and generate the same amount of click feeling at the same timing.

As described above, the click mechanism 50 is composed of the biased ball 51 and the groove Gn (n=0, 1, . . . , 16) with which the ball 51 is engaged. In the present embodiment, the ball 51 is provided on a fixed portion side of the lens barrel 20, and the groove Gn is provided on a stop ring 40 side. The ball 51 is an example of the engaging member, and the groove Gn is an example of the engaging part.

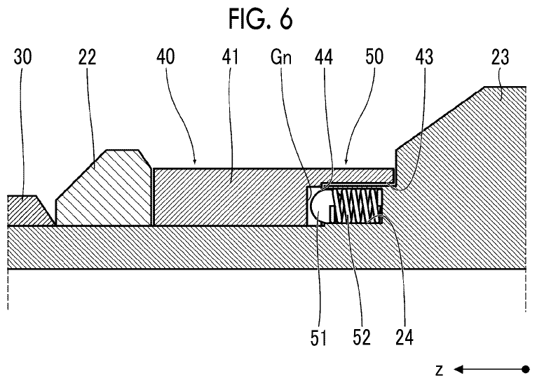

FIG. 6 is an enlarged cross-sectional view of a part of the lens barrel including the stop ring.

As shown in FIG. 6, the ball 51 is provided in the fixed cylinder 23 that constitutes the lens barrel 20. The fixed cylinder 23 is a member that is fixed with respect to the body part 2 of the camera 1. In the present embodiment, the fixed cylinder 23 is an example of the fixed unit and a base member.

The fixed cylinder 23 is provided with a ball holding hole 24 that holds the ball 51. The ball holding hole 24 is composed of a bottomed hole that is open toward the front (direction toward the object side) and is disposed along the optical axis. A spring 52 is disposed in the ball holding hole 24. The spring 52 is composed of, for example, a compression coil spring and is disposed along the optical axis. The ball 51 is biased by the spring 52 toward the front in the optical axis direction and is disposed in the ball holding hole 24 in a state where a part of the ball 51 protrudes from an opening portion of the ball holding hole 24. Therefore, the ball 51 is held to be movable along the optical axis in the ball holding hole 24, and is held to be able to appear and disappear from the opening portion.

The groove Gn is provided on an edge surface 44 of a step portion 43 provided on an inner peripheral portion of the stop ring body 41 on a base end portion side (the body part 2 side of the camera 1). The edge surface 44 of the step portion 43 is composed of a surface orthogonal to the optical axis. The groove Gn is disposed corresponding to the position (including the A-position) of each F number.

Here, in the stop ring 40 of the present embodiment, a position where the F number is set and a position (A-position) where the mode of the stop is switched to the auto mode (a mode in which the F number is automatically set) are set separately. That is, the setting of the F number is performed within a predetermined range of rotation angles, and switching to the auto mode is performed at a position outside the range.

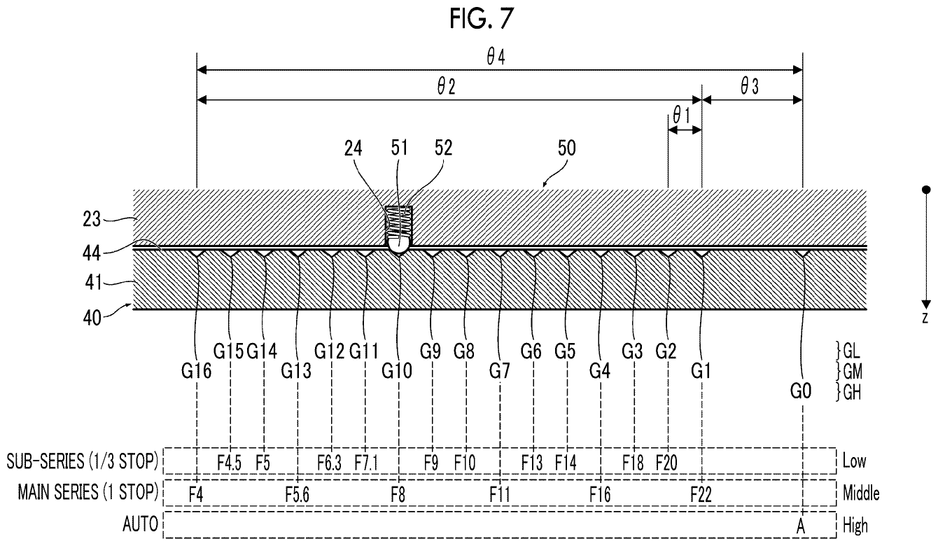

FIG. 7 is a development diagram of the grooves provided in the stop ring.

A groove with which the ball 51 is engaged at a position (A-position) where the mode of the stop is switched to the auto mode is referred to as a groove G0. In addition, a groove with which the ball 51 is engaged at a position where the F number is set to F22 is referred to as a groove G1, a groove with which the ball 51 is engaged at a position where the F number is set to F20 is referred to as a groove G2, a groove with which the ball 51 is engaged at a position where the F number is set to F18 is referred to as a groove G3, a groove with which the ball 51 is engaged at a position where the F number is set F16 is referred to as a groove G4, a groove with which the ball 51 is engaged at a position where the F number is set to F14 is referred to as a groove G5, a groove with which the ball 51 is engaged at a position where the F number is set to F13 is referred to as a groove G6, a groove with which the ball 51 is engaged at a position where the F number is set to F11 is referred to as a groove G7, a groove with which the ball 51 is engaged at a position where the F number is set to F10 is referred to as a groove G8, a groove with which the ball 51 is engaged at a position where the F number is set to F9 is referred to as a groove G9, a groove with which the ball 51 is engaged at a position where the F number is set to F8 is referred to as a groove G10, a groove with which the ball 51 is engaged at a position where the F number is set to F7.1 is referred to as a groove G11, a groove with which the ball 51 is engaged at a position where the F number is set F6.3 is referred to as a groove G12, a groove with which the ball 51 is engaged at a position where the F number is set to F5.6 is referred to as a groove G13, a groove with which the ball 51 is engaged at a position where the F number is set to F5 is referred to as a groove G14, a groove with which the ball 51 is engaged at a position where the F number is set to F4.5 is referred to as a groove G15, and a groove with which the ball 51 is engaged at a position where the F number is set to F4 is referred to as a groove G16.

The grooves G1 to G16 with which the ball 51 is engaged at the positions where the F numbers are set are disposed at a constant pitch in the circumferential direction. That is, the grooves G1 to G16 are disposed at intervals of a constant rotation angle θ1. The range of a rotation angle θ2 from the groove G1 to the groove G16 is the range of a rotation angle for setting the F number (setting range of the F number).

The groove G0 with which the ball 51 is engaged at the A-position is disposed at a position rotated by a predetermined angle from the groove G1 in a direction opposite to a setting direction (a rotation direction toward the groove G16) of the F number. A rotation angle θ3 from the groove G1 to the groove G0 is set to be larger than the rotation angle θ1 from the groove G1 to the groove G2. That is, the rotational operation amount for switching to the auto mode from the position of F22 is set to be larger than the rotational operation amount for switching the F number by ⅓ stop. Accordingly, it is possible to easily grasp the switching from the auto mode to the manual mode and the switching from the manual mode to the auto mode.

As shown in FIG. 4, each of the grooves G0 to G16 is composed of a groove (a radially extending groove) extending in the radial direction of the stop ring 40. Each of the grooves G0 to G16 is composed of a so-called tapered groove. That is, the groove is composed of a groove (a groove of which the width increases from the bottom toward the opening) that is tapered toward the bottom. In particular, in the present embodiment, the groove is composed of a groove (so-called V-shaped groove) having a V-shaped cross section.

The range of a rotation angle θ4 from the A-position (position of the groove G0) to the position (position of the groove G16) of a minimum F number (F4) is the movable range, that is, rotatable angle range of the stop ring 40.

As described above, the stop ring 40 of the present embodiment imparts a different click feeling according to the rotational position. Specifically, different click feelings are imparted to the A-position, the positions of the main-series F numbers (“F4”, “F5.6”, “F8”, “F11”, “F16”, and “F22”), and the positions of the sub-series F numbers (“F4.5”, “F5”, “F6.3”, “F7.1”, “F9”, “F10”, “F13”, “F14”, “F18”, and “F20”). The click feeling to be imparted is weakened in the order of the A-position, the positions of the main-series F numbers, and the positions of the sub-series F numbers.

In the present embodiment, the shapes (cross-sectional shapes) of the grooves G0 to G16 are set to different shapes at the A-position, the positions of the main-series F numbers, and the positions of the sub-series F numbers, so that different click feelings are realized.

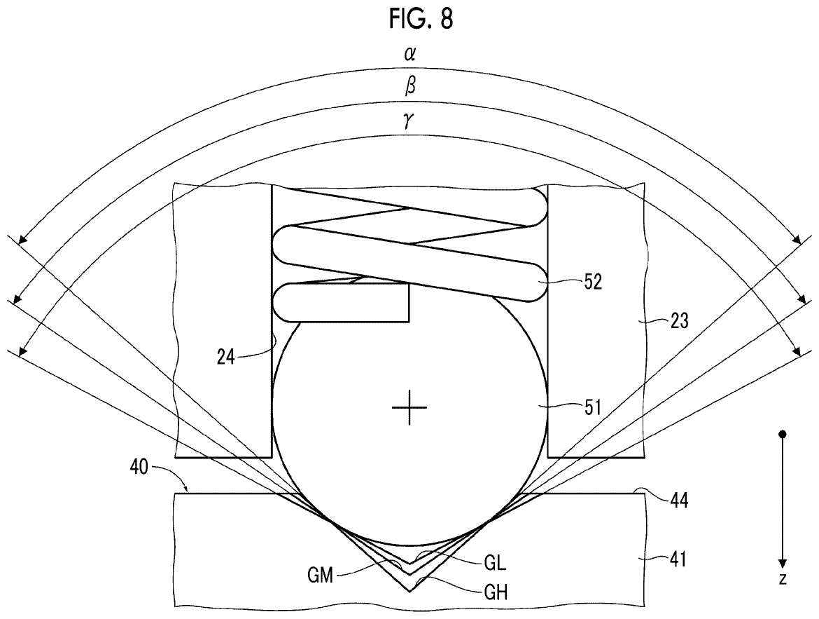

FIG. 8 is a diagram comparing the shapes of grooves at respective positions. FIG. 8 is a diagram in which grooves at respective positions are displayed in an overlapping manner.

In FIG. 8, a groove indicated by a reference numeral GH indicates a groove with which the ball 51 is engaged in a case where the stop ring 40 is set to the A-position. That is, the groove GH indicates a groove corresponding to the A-position. In addition, a groove indicated by a reference numeral GM indicates a groove with which the ball 51 is engaged in a case where the stop ring 40 is set to the position of a main-series F number. That is, the groove GM indicates a groove corresponding to the main-series F number. In addition, a groove indicated by a reference numeral GL is a groove with which the ball 51 is engaged in a case where the stop ring 40 is set to the position of a sub-series F number. That is, the groove GL indicates a groove corresponding to the sub-series F number. Hereinafter, as necessary, the groove GH is referred to as the “groove GH at the A-position”, the groove GM is referred to as the “grooves GM having the main-series F numbers”, and the groove GL is referred to as the “grooves GL having the sub-series F numbers” to distinguish the grooves. A groove G0 corresponds to the groove GH at the A-position. In addition, the grooves GM having the main-series F numbers correspond to the grooves G1, G4, G7, G10, G13, and G16. In addition, the grooves G2, G3, G5, G6, G8, G9, G11, G12, G14, and G15 correspond to the groove GL having a sub-series F number.

As shown in FIG. 8, in the present embodiment, different click feelings are realized by changing the angles of the grooves GH, GM, and GL at respective positions formed of the V-shaped groove.

Here, the “angle of a groove” is an angle formed by the inner wall surfaces on both sides of each groove composed of a V-shaped groove (tapered groove). That is, the angle of a groove is an angle formed by both inner wall surfaces formed of inclined surfaces (tapered surfaces).

In the present embodiment, each of the grooves GH, GM, and GL (groove GH=groove G0, grooves GM=grooves G1, G4, G7, G10, G13, G16, grooves GL=grooves G2, G3, G5, G6, G8, G9, G11, G12, G14, G15) has symmetry in a cross section orthogonal to a direction in which the groove extends (=radial direction of the stop ring). That is, the inner wall surfaces on both sides have the same inclined angle.

In each of the grooves GH, GM, and GL, the angle of the groove GH at the A-position is the smallest, and the angle of the groove GL having a sub-series F number is the largest. That is, in a case where the angle of the groove GH at the A-position is a, the angle of the grooves GM having the main-series F numbers is β, and the angle of the grooves GL having the sub-series F numbers is γ, a relationship of α<β<γ is satisfied.

As described above, the click feeling is the strongest at the A-position and the weakest at the position of a sub-series F number. Therefore, as the angle of a groove decreases, the click feeling becomes stronger (=as the angle of a groove increases, the click feeling becomes weaker).

Here, in a case where the click feeling at the A-position is set to “strong (high)”, the click feeling at the position of a main-series F number is set to “middle”, and the click feeling at the position of a sub-series F numbers is set to “low”, in the present embodiment, the fluctuation of the strength of the click feeling is non-linear. That is, the fluctuation in click feeling between the click feeling “weak” and the click feeling “middle” is different from the fluctuation in click feeling between the click feeling “middle” and the click feeling “strong”. Specifically, the fluctuation in click feeling between the click feeling “middle” and the click feeling “strong” is larger than the fluctuation in click feeling between the click feeling “weak” and the click feeling “middle”. In this way, by making the three-stage fluctuation in the click feeling non-linear, it is possible to easily feel the strength of the click feeling. Accordingly, it is possible to more easily grasp the operation state of the stop ring 40. That is, it is easy to grasp at which position the stop ring 40 is set.

The fluctuation in the strength of the click feeling is adjusted by changing the fluctuation in the angles α, β, and γ of the grooves GH, GM, and GL. That is, this is realized by setting a difference [β-α] between the angle α and the angle β and a difference [γ−β] between the angle β and the angle γ to be different from each other ([β−α]+[γ−β]). In the present embodiment, the difference [β−α] between the angle α and the angle β is set to be larger than the difference [γ−β] between the angle β and the angle γ ([β−α]>[γ−β]). As a result, the fluctuation in click feeling between the click feeling “middle” and the click feeling “strong” is larger than the fluctuation in click feeling between the click feeling “weak” and the click feeling “middle”.

As an example, in the present embodiment, the angle α of the groove GH at the A-position where the click feeling is “strong” is set to 95°, the angle β of the grooves GM having the main-series F numbers where the click feeling is “middle” is set to 110°, and the angle γ of the grooves GL having the sub-series F numbers where the click feeling is “weak” is set to 123°.

In this way, it is preferable that the angles α, β, and γ of the grooves GH, GM, and GL are set in an obtuse angle range (90°<α, β, γ<) 180°. Accordingly, the holdability of the stop ring 40 at each position can be improved. That is, the risk of unintentional slipping can be reduced.

In the present embodiment, as shown in FIG. 8, the ball 51 is engaged with the grooves GH, GM, and GL at respective positions at the same position in the optical axis direction (=biasing direction of the ball 51). That is, the ball 51 protrudes from the ball holding hole 24 with the same protrusion amount and is engaged with the grooves GH, GM, and GL for any of the grooves GH, GM, and GL. In other words, the grooves GH, GM, and GL are formed such that the ball 51 is engaged at the same position in the optical axis direction. The width (width of the opening) and the depth of each of the grooves GH, GM, and GL are set such that the ball 51 is engaged at the same position in the optical axis direction while satisfying angle conditions.

In the present embodiment, the A-position is an example of a first position. In addition, the position of a main-series F number is an example of a second position. In addition, the position of a sub-series F number is an example of a third position.

In addition, in the present embodiment, the groove GH (groove G0) corresponding to the A-position is an example of a first engaging part. In addition, the grooves GM (the grooves G1, G4, G7, G10, G13, and G16) corresponding to the positions of the main-series F numbers are examples of a second engaging part. In addition, the grooves GL (grooves G2, G3, G5, G6, G8, G9, G11, G12, G14, and G15) corresponding to the positions of the sub-series F numbers are examples of a third engaging part.

In addition, in the present embodiment, the click feeling (click feeling “strong”) imparted at the A-position is an example of a first click feeling. In addition, the click feeling (click feeling “middle”) imparted at the positions of the main-series F numbers is an example of a second click feeling. In addition, the click feeling (click feeling “weak”) imparted at the positions of the sub-series F numbers is an example of a third click feeling.

Meanwhile, as described above, the strength of the click feeling has a correlation with the force (torque) in the rotation direction required for the operation of switching positions, and the click feeling becomes stronger as the force required for the operation becomes larger.

The force required for the operation of switching positions has a correlation with the force acting on the stop ring 40 via the ball 51.

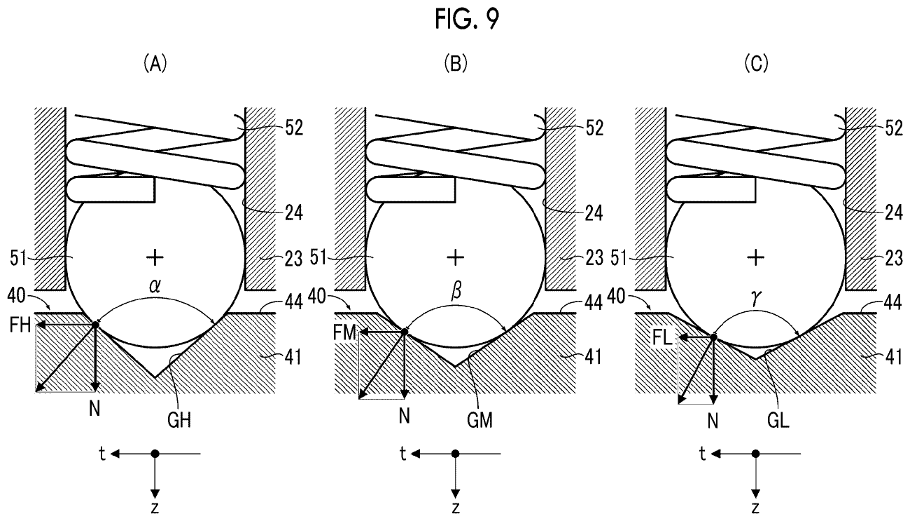

FIG. 9 is a diagram illustrating a force acting on the stop ring via the ball. (A) of FIG. 9 is an explanatory view of a force acting on the stop ring 40 at the A-position. (B) of FIG. 9 is an explanatory view of a force acting on the stop ring 40 at the positions of the main-series F numbers. (C) of FIG. 9 is an explanatory view of a force acting on the stop ring 40 at the positions of the sub-series F numbers. In FIG. 9, an arrow z indicates the direction of the optical axis. In addition, an arrow t indicates the direction of a tangent line at each of the positions of the grooves GH, GM, and GL.

As described above, in the present embodiment, the ball 51 is positioned at the same position in the optical axis direction (z direction) and is engaged with each of the grooves GH, GM, and GL. In this case, a force N in the optical axis direction acting on the stop ring 40 via the ball 51 is the same.

The force required for the operation of switching positions has a correlation with the force in a tangential direction acting on the stop ring 40 via the ball 51. That is, as the force acting in the tangential direction increases, the force required for the operation of switching positions increases.

The force acting in the tangential direction increases as the angle of a groove decreases. The angle α of the groove GH at the A-position is the smallest, and the angle γ of the grooves GL of the sub-series F numbers is the largest. Therefore, the force acting in the tangential direction is largest in a case where the ball 51 is engaged with the groove GH at the A-position. As shown in FIG. 9, in a case where a force acting on the stop ring 40 in the tangential direction in a case where the ball 51 is engaged with the groove GH at the A-position is FH, a force acting on the stop ring 40 in the tangential direction in a case where the ball 51 is engaged with each of the grooves GM of the main-series F numbers is FM, and a force acting on the stop ring 40 in the tangential direction in a case where the ball is engaged with each of the grooves GL of the sub-series F numbers is FL, the forces FL, FM, and FH acting on the stop ring 40 in the tangential direction at the respective positions have a relationship of FL<FM<FH.

In this way, as the angle of a groove increases, the force acting in the tangential direction is weakened, and the operation of switching positions can be performed with a smaller force. Therefore, as the angle of a groove increases, the click feeling becomes weaker.

As described above, in the stop ring 40 of the present embodiment, different click feelings are imparted at each of the A-position, the positions of the main-series F numbers, and the positions of the sub-series F numbers. Accordingly, it is easy to grasp the operation state of the stop ring 40. That is, it is easy to grasp at which position the stop ring 40 is set.

In addition, in the present embodiment, since three-stage click feelings are imparted by using the plurality of click mechanisms 50, a click feeling required for operation can be sufficiently imparted while reducing the size of each click mechanism 50. Accordingly, the thickness (wall thickness) required for the stop ring 40 can be reduced. Therefore, it is possible to suppress an increase in the outer diameter of the stop ring 40. That is, since the size of the click mechanism 50 is reduced, the thickness of the stop ring 40 required for incorporation can be reduced. As a result, an increase in the outer diameter of the stop ring 40 can be suppressed.

The size of the click mechanism 50 is determined by the diameter of the ball 51 to be used. As the size of the ball 51 to be used is smaller, the overall size can be smaller (in particular, the size of the ring in the radial direction can be smaller). In a case where the click mechanism 50 is used as the operation ring of the lens device, the outer diameter of the ball 51 is preferably less than @1.5 mm and more preferably less than 1.3 mm. On the other hand, in consideration of the manufacturing, assembly, and the like of the ball 51, the outer diameter of the ball 51 is preferably equal to or greater than 1.0 mm. As an example, @1.2 mm can be adopted as the outer diameter of the ball 51. Accordingly, it is possible to impart a sufficient click feeling while suppressing an increase in the outer diameter of the stop ring 40.

In addition, by disposing the plurality of the click mechanisms 50, it is possible to maintain a click feeling even in a lens having a larger diameter.

In the present embodiment, two click mechanisms are disposed in one operation ring, but the number of click mechanisms disposed in one operation ring is not limited thereto. It is preferable that the number of click mechanisms is set according to the diameter of the operation ring, and the like. Therefore, for example, three or more click mechanisms may be disposed in the operation ring having a larger diameter.

In addition, it is preferable that the plurality of click mechanisms 50 are disposed to face the rotation axis O of the stop ring 40. Specifically, the plurality of click mechanisms 50 are disposed at equal intervals in the circumferential direction. In other words, the plurality of click mechanisms 50 are disposed to be rotationally symmetric. For example, in a case where n click mechanisms are used, the n click mechanisms are symmetrically disposed n times. Accordingly, the rotational operation can be performed smoothly, and a click feeling can be imparted in a well-balanced manner.

In addition, in the present embodiment, since the shape of a groove with which the ball 51 is engaged is a tapered shape and the ball 51 is held in contact with the inner wall surface of the groove to be held, the durability of the click mechanism 50 can be improved. That is, since the ball 51 is received by a surface, the wear of the groove and the ball can be suppressed compared to a configuration (groove) in which the ball 51 is received by an edge. Accordingly, the durability can be improved.

In addition, since different click feelings are imparted depending on the angle of a groove, the three-stage click feelings can be realized with a simple configuration.

### Modification Example

### Grip Portion

In the above-described embodiment, the stop ring 40 is provided with the grip portion 42, but a configuration in which the grip portion is not provided can also be adopted.

In addition, in the above-described embodiment, the grip portion 42 is composed of the columnar protruding portions 42A, but the form of the grip portion is not limited thereto. The grip portion can also be composed of by a recessed portion (for example, an arc-shaped recessed portion) formed on the outer peripheral surface of the stop ring 40.

In a case where the grip portion 42 is provided on the stop ring 40, it is preferable that the grip portion 42 is disposed near the position of the groove G0 at the A-position. That is, it is preferable that the grip portion is disposed near the groove having the click feeling “strong”. Accordingly, it is possible to maintain the balance of power during operation, and it is possible to improve the operability of the stop ring 40. In particular, it is possible to maintain the balance of power between a case where the A-position where the click feeling is “strong” is escaped and a case where the position of a main-series F number where the click feeling is “middle” is escaped, and it is possible to provide excellent operability.

Near the groove of the click feeling “strong” means, for example, within a range having a rotation angle of 30° from the groove of the click feeling “strong”. That is, as shown in FIG. 4, this is the position where an angle δ formed by a straight line L1 passing through the center of the rotation axis O of the stop ring 40 and a groove (groove G0 at the A-position) of the click feeling “strong” and a straight line L2 passing through the center of the rotation axis O of the stop ring 40 and the protruding portion 42A constituting the grip portion 42 is less than 30° (8<) 30°.

In other words, it is preferable that the groove having the click feeling “strong” is disposed at a position where the rotation angle is less than 30° with respect to the position (the position of the center of the protruding portion 42A) of the grip portion 42. The position of the groove G0 at the A-position, which is the groove of the click feeling “strong”, is determined, whereby the positions of the grooves G1 to G16 corresponding to the positions of the F numbers are determined. As an example, the groove G0 at the A-position is disposed at a position of 25° from the position of the grip portion 42. Specifically, in a case where the stop ring 40 is rotated counterclockwise to be disengaged from the A-position, the groove G0 at the A-position is disposed at a position rotated clockwise by 25° from the position of the grip portion 42.

### Engaging Member

In the above-described embodiment, the ball 51 biased by the spring 52 is adopted as the engaging member, but the configuration of the engaging member and the biasing method thereof are not limited thereto.

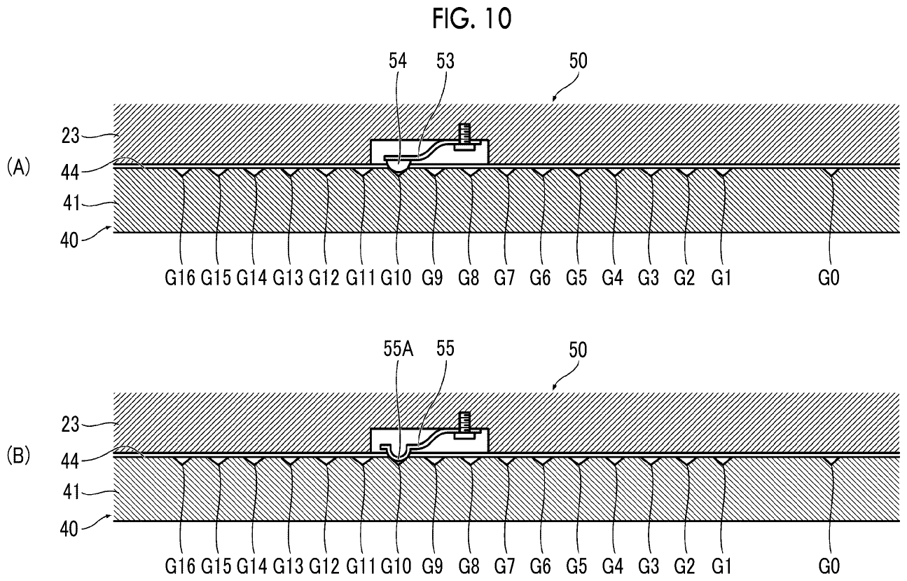

FIG. 10 is a view showing another example of the engaging member.

(A) of FIG. 10 is a diagram showing an example of a case where a biasing member is composed of a hemispherical body and the biasing member is formed of a leaf spring. As shown in (A) FIG. 10, in the present example, a hemispherical body 54 is provided at a distal end of the leaf spring 53. The hemispherical body 54 is biased toward the front side (stop ring side) in the optical axis direction by the leaf spring 53. By rotating the stop ring 40, the hemispherical body 54 is engaged with the groove Gn, and a click feeling is imparted.

In this way, the engaging member is not limited to the ball as a sphere, and a hemispherical shape can also be adopted. In addition, a member having a spheroidal shape and a semi-spheroidal shape can also be adopted as the engaging member. That is, a member of which at least a portion is formed in a spherical shape can be adopted as the engaging member. In this case as well, the outer diameter (the outer diameter of a spherical portion) is preferably equal to or greater than @1.0 mm and less than $1.5 mm, and more preferably equal to or greater than $1.0 mm and less than Ø1.3 mm.

Similarly, as the biasing member, other spring materials such as the leaf spring shown in the present example can also be used in addition to the compression coil spring.

(B) of FIG. 10 is a view showing an example of a configuration in which the biasing member and the engaging member are integrated with each other. In the present example, an arc-shaped (for example, U-shaped) protruding portion 55A that functions as an engaging member is provided at a tip portion of the leaf spring 55. The arc-shaped protruding portion 55A is integrally provided on the leaf spring 55, for example, by bending. Even in the present configuration, the stop ring 40 is rotated, so that the arc-shaped protruding portion 55A is engaged with the groove Gn, and a click feeling is imparted.

In this way, a configuration in which the biasing member and the engaging member are integrated with each other can also be adopted. In addition, the engaging member can have an arc shape. In this case as well, the outer diameter (arc width) of an arc portion is preferably 1.0 mm or more and less than 1.5 mm, and more preferably 1.0 mm or more and less than 1.3 mm.

### Engaging Part

In the above-described embodiment, the tapered groove Gn is adopted as the engaging part, but the configuration of the engaging part is not limited thereto.

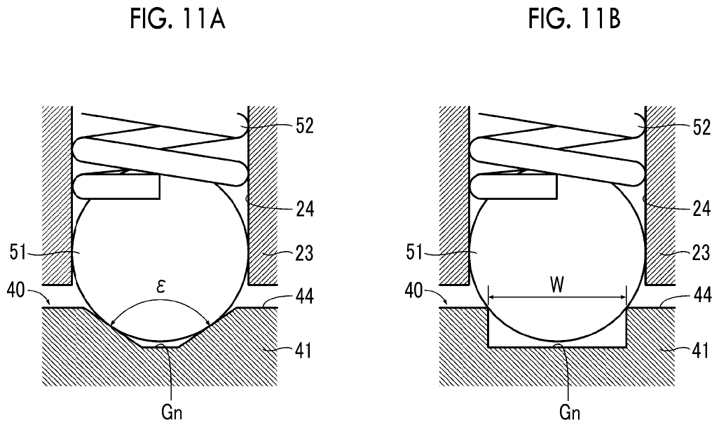

FIGS. 11A and 11B are views showing another example of the engaging part.

FIG. 11A is a view showing an example of a case where the engaging part is composed of a tapered groove having a bottom surface. As shown in FIG. 11A, in the case of a groove having a configuration in which the ball 51 is received on an inclined inner wall surface, the shape (cross-sectional shape) thereof is not limited to a V-shape, and may be a shape (inverted trapezoidal shape) having a bottom surface. In this case as well, the strength of the click feeling is adjusted by an angle ε (an angle formed by the inner wall surfaces on both sides) of a groove.

FIG. 11B is a view showing an example of a case where the engaging part is composed of a groove having a rectangular cross section. In this case, the click feeling is adjusted by the width w of the groove Gn.

In consideration of the durability, it is preferable that the engaging part is composed of a tapered groove having an inclined inner wall surface.

In addition, in a case where the engaging part is composed of a tapered groove, it is preferable that the angle of a groove is set in an obtuse angle range.

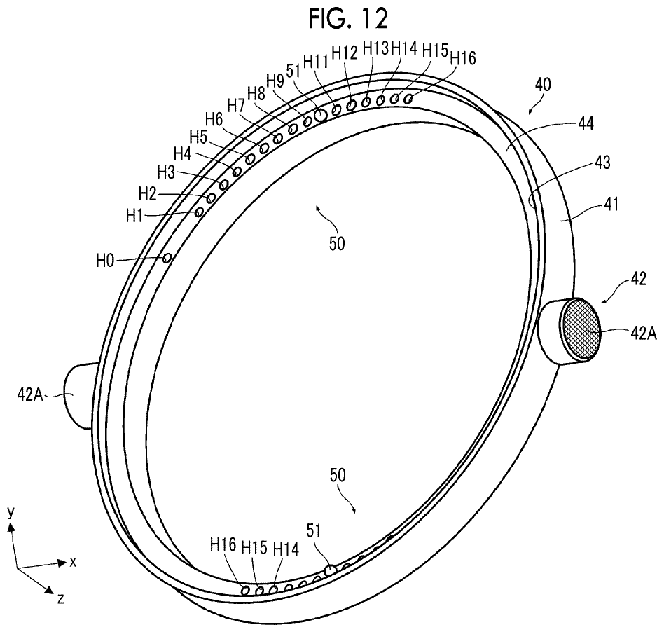

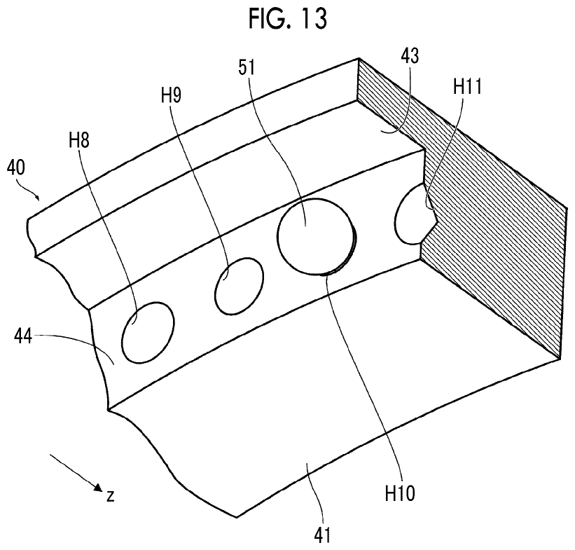

FIG. 12 is a diagram showing another example of the engaging part and is a perspective view of the stop ring as viewed from the rear side. FIG. 13 is an enlarged view of a part of the stop ring shown in FIG. 12.

FIGS. 12 and 13 show an example of a case where the engaging part is composed of holes H0, H1, . . . , and H16. As shown in FIG. 13, each of the holes H0, H1, . . . , and H16 has a conical shape. In the case of the present example, the strength of the click feeling is adjusted by changing an apex angle. As the apex angle is larger, the click feeling is set to be weaker. Accordingly, the apex angles of the holes H1, H4, H7, H10, H13, and H16 at the positions of the main-series F numbers are set to be larger than the apex angle of the hole H0 at the A-position, and the apex angles of the holes H2, H3, H5, H6, H8, H9, H11, H12, H14, and H15 at the positions of the sub-series F numbers are set to be larger than the apex angles of the holes H1, H4, H7, H10, H13, and H16 at the positions of the main-series F numbers. In this case as well, it is preferable that the apex angle of each hole is set in an obtuse angle range.

In this way, the engaging part can also be composed of a hole in addition to the groove. That is, the engaging part can be composed of a recessed portion.

In the present example, the hole is formed in a conical shape, but the shape of the hole is not limited thereto. In addition, for example, the hole can also be formed in a truncated conical shape. In addition, the hole can also be composed of a columnar hole. In this case, the strength of the click feeling is adjusted depending on the diameter of the hole.

### Click Mechanism

In the above-described embodiment, the configuration is adopted in which the groove (engaging part) is disposed on the stop ring side and the ball (engaging member) is disposed on the fixed unit side of the lens barrel, but the disposition relationship between the groove and the ball may be reversed. That is, a configuration may be adopted in which a groove is disposed on the fixed portion side of the lens barrel and a ball is disposed on the stop ring side. A configuration can be adopted in which the engaging part and the engaging member are disposed such that the engaging part is disposed on one of a movable side and the fixed side and the engaging member is disposed on the other side.

In addition, in the above-described embodiment, the configuration is adopted in which a groove is disposed on the surface orthogonal to the optical axis, and the ball is biased in the optical axis direction to engage the groove and the ball with each other, but the configuration in which the groove and the ball are engaged with each other is not limited thereto. For example, a configuration may be adopted in which a groove is disposed on an inner peripheral surface of the stop ring, and the ball is biased in the radial direction to engage the groove and the ball with each other.

### Other Modification Examples

In the above-described embodiment, the case where the present invention is applied to the operation device that operates the stop of the lens has been described as an example, but the application of the present invention is not limited thereto. The present invention can be widely applied to operation devices that perform various operations with the annular operation member (operation ring) that is rotationally operated.

In a case where the present invention is applied to the operation device that performs the operation of the stop, in addition to changing the click feeling between the main-series F numbers and the sub-series F numbers, as described in the above-described embodiment, it is preferable to set a click feeling to be changed between the F numbers and a position where other settings (settings other than the F number) are performed, In this case, it is preferable that the click feeling of the position where the other settings are performed is the strongest. In addition, in the above-described embodiment, the function of switching modes is assigned to the position where the other settings are performed, but the other functions may be assigned. In addition, a plurality of positions where the other settings are performed may be provided.

In addition, in the above-described embodiment, the configuration is adopted in which the F number is switched by each ⅓ stop but the aspect in which the F number is switched is not limited thereto. For example, a configuration may be adopted in which the switching is performed by ½ stop or ¼ stop. Even in this case, it is preferable to change the strength of the click feeling between the positions of the main-series F numbers and the positions of the sub-series F numbers.

In addition, in the above-described embodiment, the case where the present invention is applied to the operation member that is rotated in a certain angular range has been described as an example, but the present invention can also be applied to an operation member that can be rotated without limitation.

In addition, in the above-described embodiment, the example in which the present invention is applied to the lens device provided in the lens-integrated camera has been described, but the application of the present invention is not limited thereto. The present invention can be similarly applied to a lens device (so-called interchangeable lens) of an interchangeable lens camera.

In addition, in the above-described embodiment, the case where the present invention is applied to the imaging apparatus and the lens device used for the imaging apparatus has been described as an example, but the application of the present invention is not limited thereto. The present invention can be widely applied to a lens device including an annular operation member (operation ring) that is rotationally operated, and an optical device using the lens device. In addition, the present invention can be widely applied to a device comprising an annular operation member that is rotationally operated, in addition to the lens device.

Each of the above modification examples can be used in combination as appropriate.

### Supplementary Note

In the present specification, the meanings of the terms “the same” and “identical” include not only a meaning of “completely identical” but also a meaning of “substantially the same” including an error allowed in design and manufacturing.

In addition, in the present specification, the meanings of the terms “simultaneously”, “synchronously”, “the same amount”, and the like include not only the meanings of “completely simultaneously”, “completely synchronously”, “completely the same amount”, and the like but also the meanings of “substantially simultaneously”, “substantially synchronously”, “substantially the same amount”, and the like.

In addition, in the present specification, the meaning of the term “symmetric” includes not only the meaning of “completely symmetric” but also the meaning of “substantially symmetric” including an error allowed in design and manufacturing.

In addition, in the present specification, the meaning of the term “facing” includes not only the meaning of “completely facing” but also the meaning of “substantially facing” including an error allowed in design and manufacturing.

In addition, in the present specification, the meaning of the term “orthogonal” includes not only the meaning of “completely orthogonal” but also the meaning of “substantially orthogonal” including an error allowed in design and manufacturing.

In addition, in the present specification, the meaning of the term “constant” includes not only the meaning of “completely constant” but also the meaning of “substantially constant” including an error allowed in design and manufacturing.

In addition, in the present specification, the meaning of the term “center” includes not only the meaning of “completely a center” but also the meaning of “substantially a center” including an error allowed in design and manufacturing.

In addition, in the present specification, the meanings of the terms “sphere” and “hemisphere” include not only the meanings of “completely a sphere” and “completely a hemisphere” but also the meanings of “substantially a sphere” and “substantially a hemisphere” including an error allowed in design and manufacturing.

### EXPLANATION OF REFERENCES

1: camera
2: body part
3: lens part
4: finder
5: monitor
10: power lever
11: shutter button
12: exposure correction dial
13: shutter speed dial
14: command dial
15: DISP/BACK button
16: play button
17: MENU/OK button
18: focus lever
19: function button
20: lens barrel
21 indicator
22: fixed ring
23: fixed cylinder
24: ball holding hole
30: focus ring
40: stop ring
41: stop ring body
42: grip portion
42A: protruding portion
43: step portion of stop ring body
44: edge surface of step portion
50: click mechanism
51: ball
52: spring
53: leaf spring
54: hemispherical body
55: leaf spring
55A: protruding portion of leaf spring
FH: force in tangential direction acting on stop ring in case where stop ring is engaged with groove at A-position
FM: force in tangential direction acting on stop ring in case where stop ring is engaged with groove having main-series F number
FL: force in tangential direction acting on stop ring in case where stop ring is engaged with groove having sub-series F number N: force in optical axis direction acting on stop ring
Gn (=G0 to G16): groove
GH (=G0): groove at A-position
GM (=G1, G4, G7, G10, G13, G16): groove having main-series F number
GL (=G2, G3, G5, G6, G8, G9, G11, G12, G14, G15): groove having sub-series F number
H0 to H16: hole
L1: straight line passing through rotation axis of stop ring and center of groove at A-position
L2: straight line passing through rotation axis of stop ring and center of protruding portion of grip portion
O: rotation axis of stop ring
t: direction of tangent line
w: width of groove
z: direction of optical axis
α: angle of groove at A-position
β: angle of groove having main-series F number
γ: angle of groove having sub-series F number
δ: angle formed by straight line L1 and straight line L2
ε: angle of groove
θ1: rotation angle from groove G1 to groove G2 (disposition interval between groove G1 and groove G16)
θ2: rotation angle from groove G1 to groove G16
θ3: rotation angle from groove G1 to groove G0
θ4: rotation angle (movable range of stop ring) from A-position to position of minimum F number

What is claimed is:

1. An operation device comprising:
a base member;
an annular operation member that is provided on the base member and is rotatable around an axis; and
a click mechanism that imparts a first click feeling at a first position, imparts a second click feeling weaker than the first click feeling at a second position, and imparts a third click feeling weaker than the second click feeling at a third position, with respect to rotation of the operation member,
wherein a plurality of the click mechanisms are disposed.

2. The operation device according to claim 1,
wherein the plurality of click mechanisms are disposed to face the axis.

3. The operation device according to claim 2,
wherein the click mechanism includes
an engaging member that is provided on one of the base member and the operation member and that is biased toward the other,
a first engaging part that is provided on the other of the base member and the operation member and with which the engaging member is engaged in a case where the operation member is positioned at the first position,
a second engaging part that is provided on the other of the base member and the operation member and with which the engaging member is engaged in a case where the operation member is positioned at the second position, and
a third engaging part that is provided on the other of the base member and the operation member and with which the engaging member is engaged in a case where the operation member is positioned at the third position, and
shapes of the first engaging part, the second engaging part, and the third engaging part are different from each other.

4. The operation device according to claim 3,
wherein at least a portion of the engaging member is formed in a spherical shape or an arc shape, and
the first engaging part, the second engaging part, and the third engaging part are composed of recessed portions.

5. The operation device according to claim 4,
wherein each of the recessed portions has a tapered inner wall surface, and an angle formed by the inner wall surface differs between the first engaging part, the second engaging part, and the third engaging part.

6. The operation device according to claim 5,
wherein, in a case where the angle in the first engaging part is α, the angle in the second engaging part is β, and the angle in the third engaging part is γ, a relationship of α<β<γ is satisfied.

7. The operation device according to claim 6,
wherein a difference between the angle α and the angle β is different from a difference between the angle β and the angle γ.

8. The operation device according to claim 7,
wherein a difference between the angle α and the angle β is larger than a difference between the angle β and the angle γ.

9. The operation device according to claim 6,
wherein the angle α, the angle β, and the angle γ are obtuse angles.

10. The operation device according to claim 3,
wherein the engaging member is engaged with the first engaging part, the second engaging part, and the third engaging part at the same position in a biasing direction.

11. The operation device according to claim 4,
wherein an outer diameter of the portion having the spherical shape or the arc shape is less than 1.5 mm.

12. The operation device according to claim 3,
wherein the operation member has a grip portion, and
the grip portion is disposed at a position at a rotation angle of less than 30° from a position of the first engaging part.

13. The operation device according to claim 1,
wherein a plurality of the second positions and a plurality of the third positions are provided within a predetermined range of rotational angles, and
the first position is provided at a position outside the range.

14. The operation device according to claim 1,
wherein a plurality of the second positions are provided within a predetermined range of rotational angles, and
the third position is provided between the second positions adjacent to each other.

15. The operation device according to claim 14,
wherein a plurality of the third positions are provided between the second positions adjacent to each other.

16. A lens device comprising:
the operation device according to claim 1,
wherein the base member constitutes a fixed portion of a lens barrel, and the operation member constitutes an operation ring provided on an outer periphery of the lens barrel.

17. An imaging apparatus comprising:
the lens device according to claim 16; and
a main body that captures an image formed by the lens device.
